(19) United States
(12) Patent Application Publication
(10) Pub. No.: US 2016/0129481 A1
(43) Pub. Date: May 12, 2016

(54) CLEANING HEAD APPARATUS

(71) Applicant: Aviram Mann, Modiin (IL)

(72) Inventor: Aviram Mann, Modiin (IL)

(21) Appl. No.: 14/538,825

(22) Filed: Nov. 12, 2014

(51) Int. Cl. B08B 1/00; A47L 11/28; A47L 11/38; B08B 5/04; A47L 11/40

(52) U.S. Cl. CPC B08B 1/006; B08B 5/04; A47L 11/4083; A47L 11/4036; A47L 11/38; A47L 11/28

(57) ABSTRACT

The present invention discloses a cleaning head apparatus operated by a carrier unit for cleaning a target surface. The cleaning head apparatus is comprised of: at least two loop straps attached next to each other by a main structured, each strap stretched and rolled on two axles operated by an engine, wherein at each cleaning session each strap has one part in dry state and one part of the in wet state, drying mechanism and wetting mechanism. The rolling of the straps is controlled, such that straps are not rolled during the movement of the cleaning head apparatus across the surface and are rolled, when the cleaning head apparatus reaches the edge of the target surface. During the cleaning movement, the wet strap is ahead of the dry strap and the straps are in constant contact with the surface.

### FIELD OF THE INVENTION

The present invention relates generally to methods and systems for cleaning surfaces, and more specifically to methods and apparatus for cleaning head enabling continuous cleaning.

### BACKGROUND OF THE INVENTION

There in a need for cleaning large surface, such as windows of building or solar panels. Today most cleaning operations are preformed manually, by human workers.

The cleaning head apparatus as suggested by the present invention in intended for continuously, cleaning surface such as windows, floors or solar surfaces in horizontal or vertical orientation. Known in the art cleaning heads using brushed are required to rotate and or to retract in relation to the surface, therefore unsuitable for sunk surface.

The cleaning head apparatus is designed to be connected a carrier unit by hanging or by moving the cleaning head apparatus along a surface.

### SUMMARY OF THE INVENTION

The present invention provides a cleaning head apparatus operated by a carrier unit for cleaning a target surface, wherein the carrier unit moves the cleaning head apparatus along the target surface. The cleaning head apparatus comprised of: at least two loop straps attached next to each other by a main structured, each strap stretched and rolled on two axles operated by an engine, wherein at each cleaning session each strap has one part in dry state and one part in wet state, such that the dry part faces opposite direction of the wet part, drying mechanism for operating on at least one part of the strap at pre-defined time period and wetting mechanism for spraying fluid at least one part of the strap at pre-defined time period

According to some embodiments of the present invention at each cleaning session the cleaning head apparatus moves along at least one predefined path.

According to some embodiments of the present invention the rolling of the straps is controlled, such that straps are not rolled during the movement of the cleaning head apparatus across the surface and are rolled, when the cleaning head apparatus reaches a pre-defined location along the target surface, such as part of the time the dry side faces the surface and part of the time the wet side faces the surface.

According to some embodiments of the present invention the strap with the wet part is facing the surface ahead of strap with the dry part facing the surface, in relation to the cleaning head apparatus movement direction.

According to some embodiments of the present invention the straps are rolled when the cleaning apparatus reaches the edge of the target surface.

According to some embodiments of the present invention the drying mechanism is activated during the enrolment of the straps toward a part of one strap which is currently in wet status, once the cleaning apparatus reaches the end of the of the surface.

According to some embodiments of the present invention the wetting mechanism is activated during the enrolment of the straps toward a part of one strap which is currency in dry status, once the cleaning apparatus reaches the end of the of the surface.

According to some embodiments of the present invention the cleaning head apparatus of further comprises a squeegee integrated in-between the two straps such as the squeegee swap the water left on the surface.

According to some embodiments of the present invention the cleaning head apparatus further comprises a vacuum entrance integrated in-between the two straps such as the vacuum device draw the water left on the surface.

According to some embodiments of the present invention the carrier unit comprises a vacuum pump for operating the vacuum entrance, a fluid source for wetting the straps and energy source for operating the engine.

According to some embodiments of the present invention the straps constantly are in contact with the target surface, at each cleaning session when the cleaning head apparatus moves along a predefined path and when the changes location between different paths.

According to some embodiments of the present invention the engine creates polishing movements of the straps, by moving thereof slightly back and forth during the cleaning session when the cleaning head apparatus moves along a predefined path.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a pictorial illustration showing cleaning head apparatus according to some embodiments of the present invention.

FIG. 1A is a pictorial illustration showing the side view of the straps of the cleaning head apparatus according to some embodiments of the present invention.

FIG. 2 is a simplified pictorial illustration scheme showing a movement direction of the cleaning head apparatus according to some embodiments of the present invention.

FIG. 3 is a pictorial illustration showing a carrying unit implanting the cleaning head apparatus, according to some embodiments of the present invention.

FIG. 4 is a simplified pictorial illustration of the transporter conveying the cleaning head apparatus according to some embodiments of the present invention.

FIG. 5 is a simplified pictorial illustration of the transporter alternative implementation for stabilizing the movement of the cleaning head apparatus according to some embodiments of the present invention.

FIG. 6 is a simplified pictorial illustration of the supporting arm(telescopic) for holding cleaning head apparatus according to some embodiments of the present invention.

FIGS. 7A and 7B are a simplified pictorial illustration of the carrying unit enabling to maintain straight cleaning stripe path during the movement of the carrier unit according to some embodiments of the present invention.

### DETAILED DESCRIPTION OF THE EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

The present invention discloses a cleaning head apparatus installed on a carrier unit which moves continuously above target surface for cleaning The cleaning head apparatus is comprised of a wet element for wetting the surface, a squeegee and vacuum pump for absorbing the dirty fluids and dry element for drying and polishing the surface. There are two cleaning elements on each head, where each cleaning element can change it's state from wet to dry and vice versa. The cleaning head apparatus moves along straight adjacent stripes, at the end of each stripe the cleaning head apparatus moves upwards toward the next stripe and change the status of each cleaning head apparatus, such as the cleaning element in the wet status is always located before the cleaning element in the dry status. This working method enable continuous cleaning, one stripe after the other maintaining constant contact with the target surface, not requiring to retract away the cleaning head apparatus from the surface

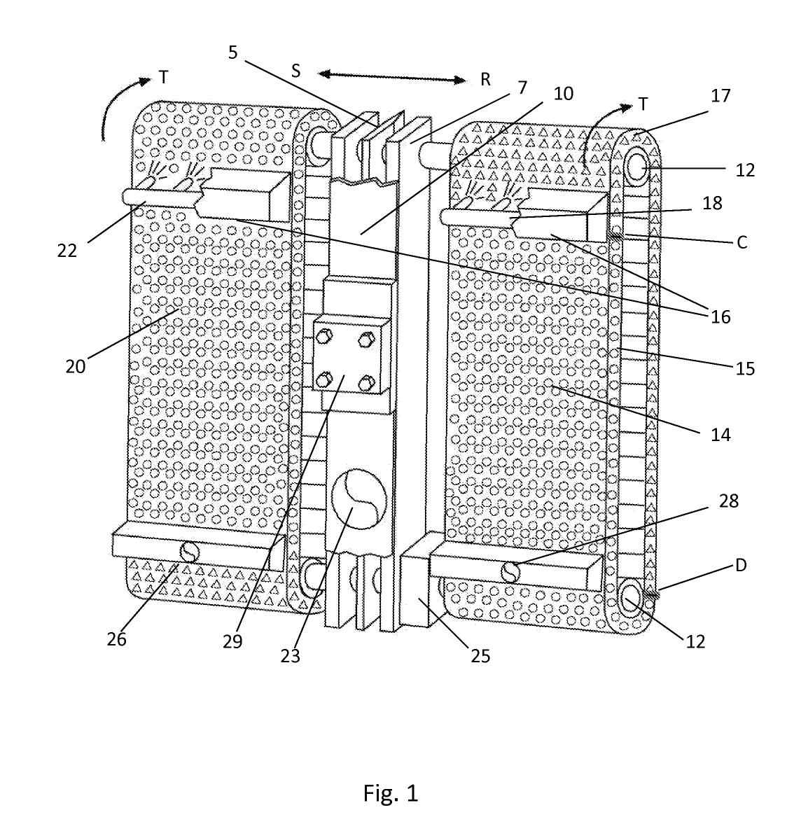

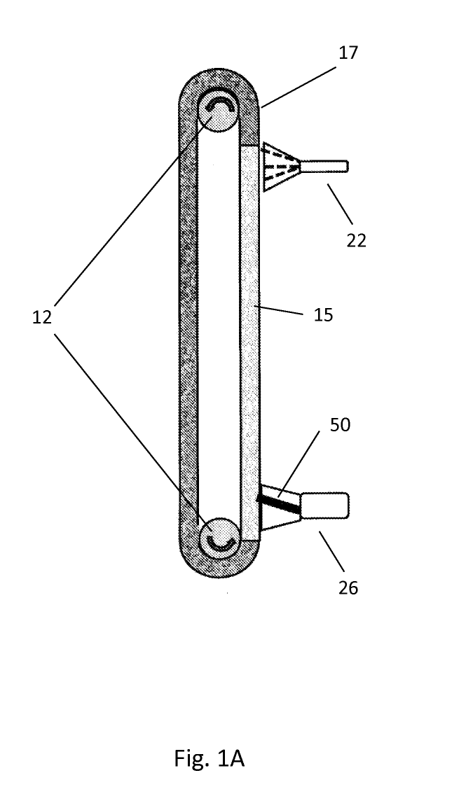

FIG. 1 is a pictorial illustration showing cleaning head apparatus according to some embodiments of the present invention. The cleaning head apparatus is comprised of two loop straps 20 and 14, each starched and rolling on two axles 12 attached by structure 10 operated by an electric or hydraulic engine 25. At each cleaning session, the engine rotate each strap from point D to point C in direction T, such that each strap is partly maintained in dry state 15 (see the part having circles pattern) on one part of the strap and partly maintained in wet state 17 on a second part of the strap (see the part having triangle pattern), such that the dry part faces opposite direction of the wet part, a drying mechanism 28 and 26 are using vacuum or applying hot air (operating in association with the squeegee) for drying the wet part and a wetting mechanism 18, 22 having cover 16 for splashing/spraying fluid/water at the a dry part of the strap. The two axis and the straps are connected by a main structure 10 comprised of a squeegee 5, covers 7, a vacuum entrance 23 and connector 29 to be attached to a carrier unit. The carrier unit includes a vacuum pump connected to vacuum entrances 23, 26 and 28, a water supplying means for providing fluid to the spraying units and energy source for the engine 25.

According to some embodiments of the present invention it is suggested to creating polishing movements of the straps, to move slightly back and forth(e.g. up and down) during the cleaning session when the cleaning head apparatus moves along a predefined path. This movement is activated by the engine 25.

The stripes are rolled from point D to point C in direction T, when the reaches a pre-defined location along the target surface, such as part the time the wet part faces the surface and part of the time the dry part faces the surface. One schedule of operation may be defined to roll the straps when reaching the edge of the cleaned surface, the straps are rolled, such that the dry part and the wet part exchange their orientation: incase the wet part faced the cleaning surface, its exchanges location with dry part. At each cleaning session/period one wet part of one strap faces the target surface and one dry part of the second loop faces the target surface, such as strap with the wet part facing the target surface is ahead of the strap the dry part in relation to the cleaning unit movement direction. When reaching the edge of the cleaned surface, the drying unit is activated for drying the wet part which is not facing the target surface and the wetting unit is activated to wet the dry part of the strap which is not facing the target surface

FIG. 1A is a pictorial illustration showing the side view of the straps of the cleaning head apparatus according to some embodiments of the present invention.

During the movement of the engine to roll axles 12, the wetting mechanism 22 is wetting the dry surface 15, while the squeegee 50 is swapping the dirt from the wet surface 17 and the drying mechanism 26 absorb the water and the dirt

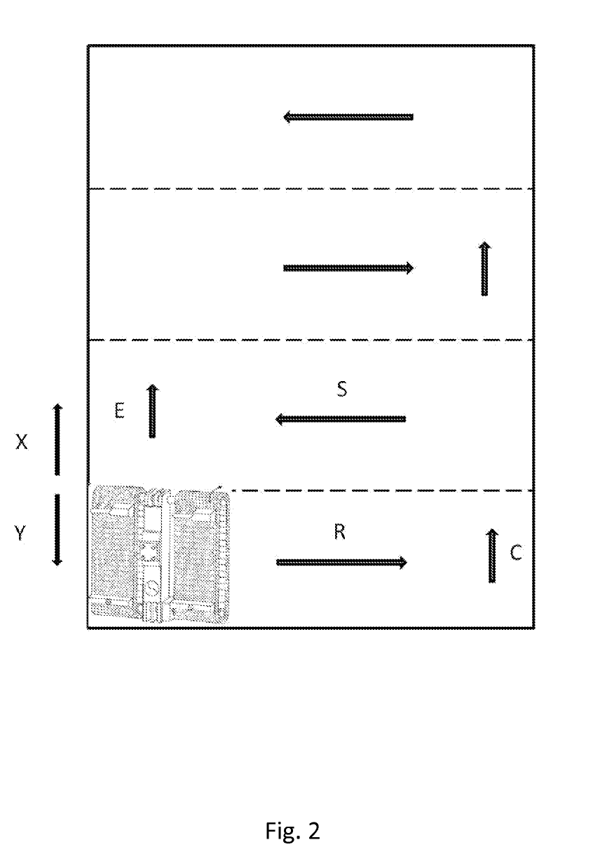

FIG. 2 is a simplified pictorial illustration scheme showing a movement direction of the cleaning head apparatus according to some embodiments of the present invention. The carrier unit moves the cleaning head apparatus in direction R to right side toward area C. Once the cleaning head apparatus reached the edge of the surface it moves upwards in direction X to the next stripe.

Before moving to the cleaning head apparatus to left and starting the next cleaning session, the cleaning head apparatus activates the engine for rotating each strap (in direction T) for exchanging currently dry part with wet part, such that the strap with the wet part facing the target surface is ahead of the second strap with the dry part facing the surface. During the rotation of the straps, the drying mechanism is activated for drying the wet part of the one of the straps which is not facing the target surface and activating the wetting unit for wetting the dry part which is not facing the target surface. Once the straps rolled and the drying and wetting actions have finished, the cleaning moves to the left indirection S, toward area E.

At the edge E the cleaning head apparatus moves upward (in direction X) to next stripe (rolling the straps and activating the wetting and drying process as described above) and then to the right indirection R. The movement path continues according to same pattern at the next stripes.

Optionally the cleaning head apparatus may move in reverse direction Y (e.g. down).

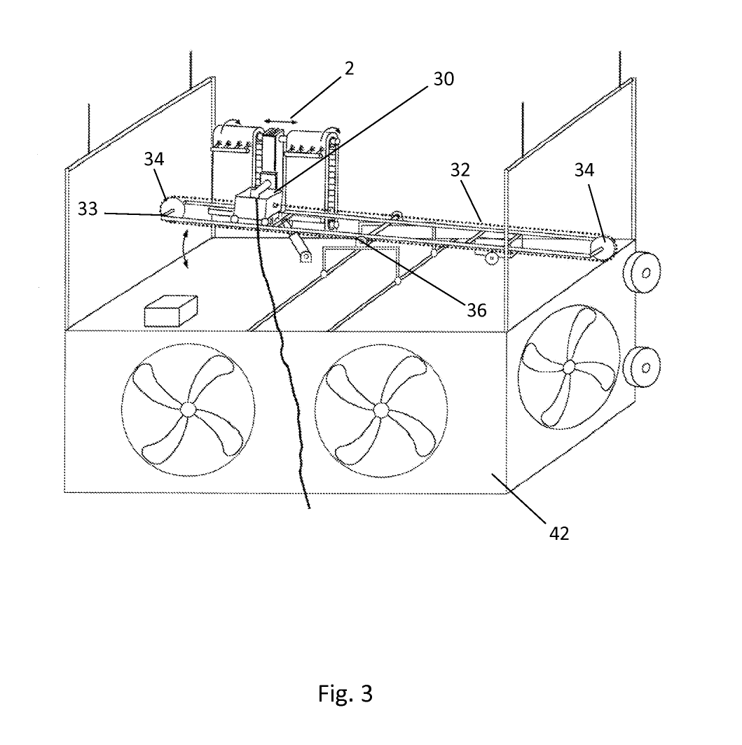

FIG. 3 is a pictorial illustration showing cleaning systems integrated with the cleaning head apparatus, according to some embodiments of the present invention. The cleaning head apparatus 2 is installed on carrying unit 30 which moves on a swinging mechanism which comprise a chain 32 mounted on wheels 34, said wheel connected the frame 33 installed on the swinging device 36. The swinging device with integration of the chain movement enable to move horizontally the cleaning head apparatus 2 across the target surface and maintaining the motion along the surface in straight line while the whole cleaning system moves up and down. The swinging device is mounted on the chassis 42.

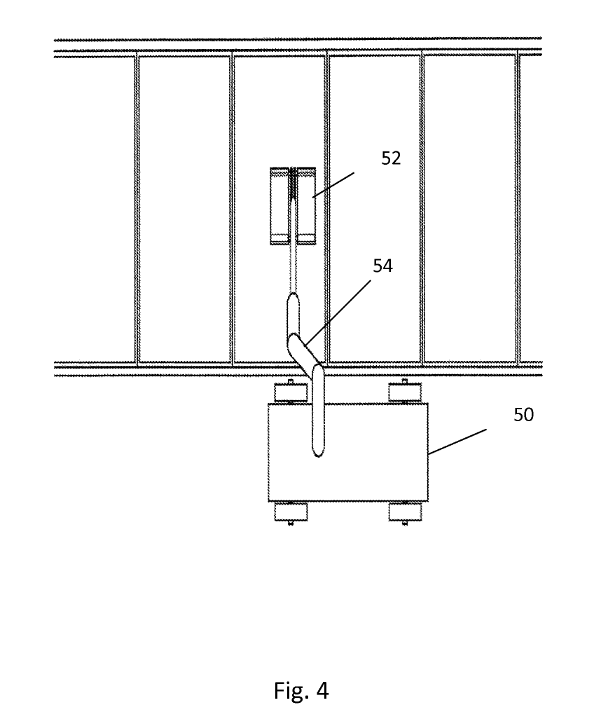

FIG. 4 is a simplified pictorial illustration of the transporter conveying the working equipment according to some embodiments of the present invention. The conveyer transporter 50 is holding the cleaning head apparatus 52 by arm 54. The conveyor is movable on surface parallel to the cleaning surface.

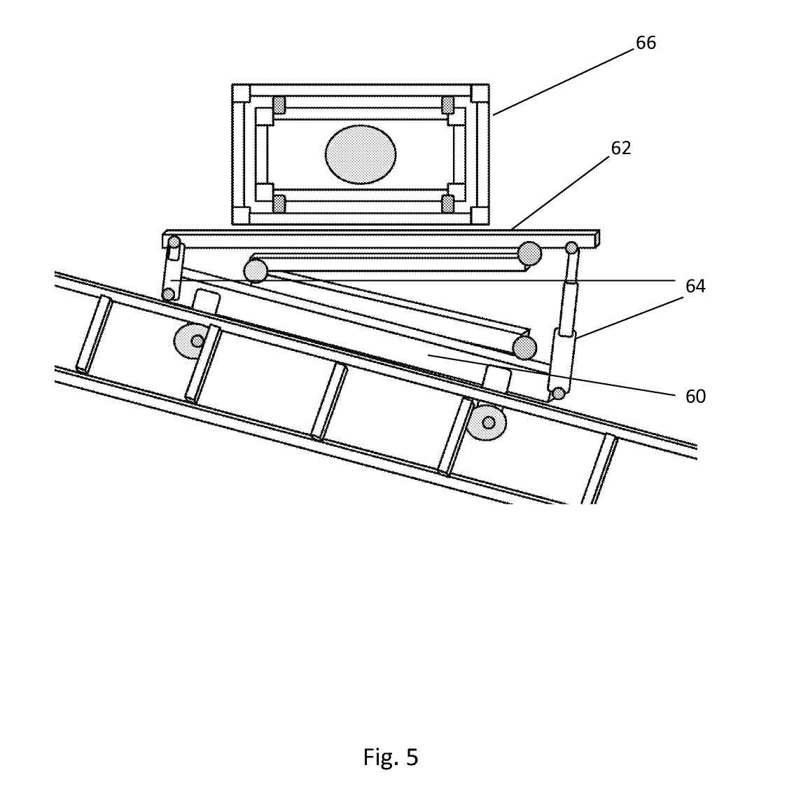

FIG. 5 is a simplified pictorial illustration of the transporter alternative implementation, according to some embodiments of the present invention. According to this embodiment the carrying unit apparatus is designed to stabilize the movement of the cleaning head apparatus to move in straight line. The carrying unit 60 has telescopic arms 64 at each side and supporting element 62. The telescopic arms are opened and closed in accordance with traveling direction of the carrying unit 60, such that when the carrying unit moves to the right downwards, the right telescopic arm is opened upwards, such that the cleaning head apparatus is oriented in straight line in relation to the surface. When the carrying unit moves to the left upwards, the left telescopic arm is opened downwards, such that the cleaning head apparatus is oriented in straight line in relation to the surface

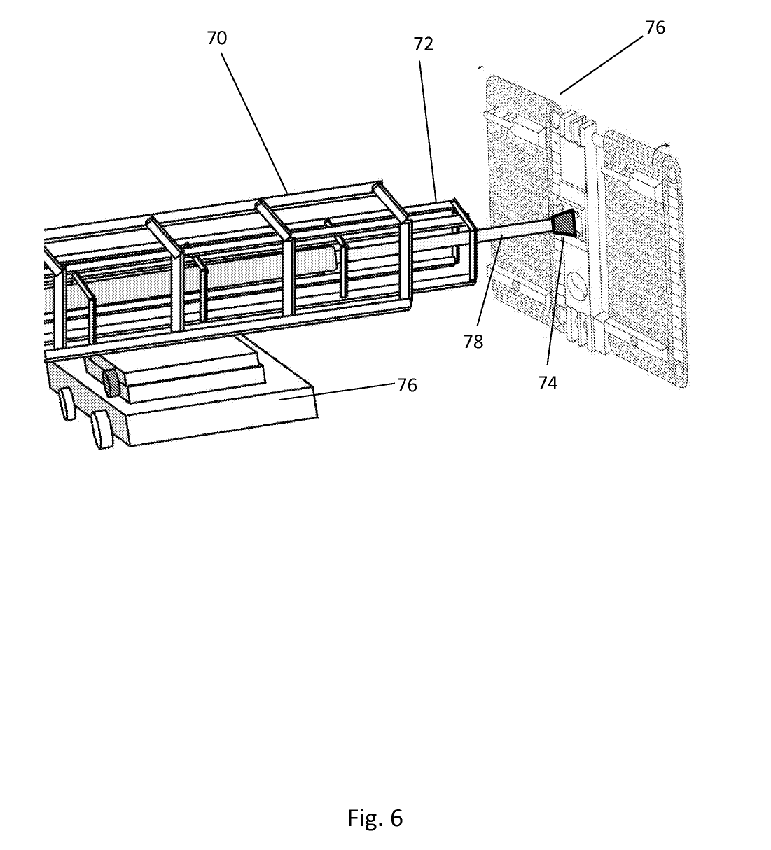

FIG. 6 is a simplified pictorial illustration of the supporting arm (telescopic) for holding working equipment according to some embodiments of the present invention. According to some embodiments of the present invention the supporting arm is comprised of telescopic elements 70 and 72 and piston 78. The piston 78 is connected directly to the cleaning head apparatus and the inner telescopic arm is connected to the cleaning head apparatus by a flexible connection 74. This structure of the arm provides flexibility in the movement of the cleaning head apparatus to overcome obstacles in the surface. The telescopic element 70 is attached to the carrying unit 76.

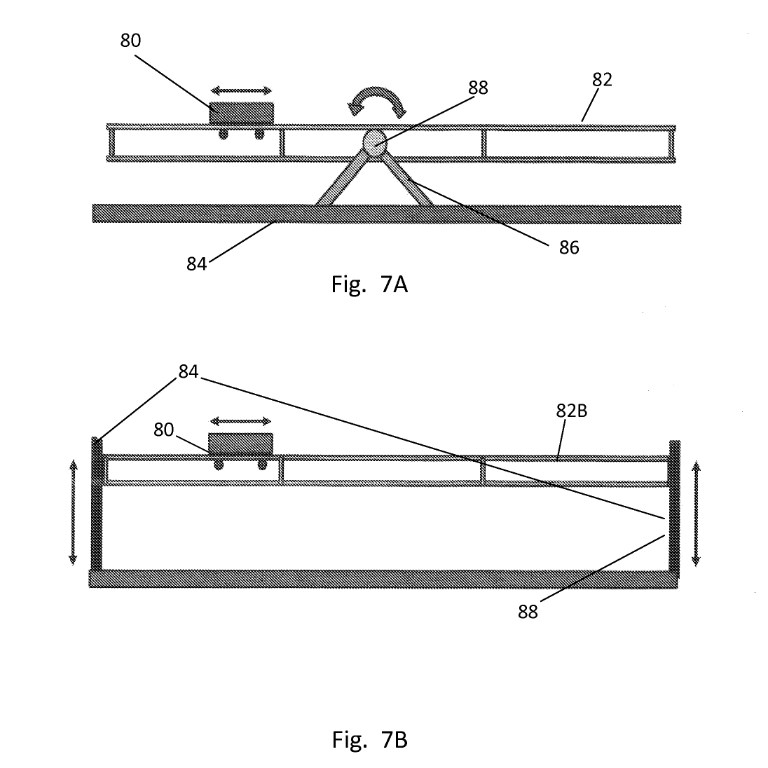

FIG. 7A are a simplified pictorial illustration of the swinging mechanism which enables horizontal movement in strait line, when the cleaning head apparatus moves vertically continuously, according to some embodiments of the present invention. According to FIG. 7A the swinging mechanism is comprised rail 82 mounted on triangular structure 86 having axis 88 on which the rails wings. The trolley 80 which carry the cleaning head apparatus moves along the rail 82.

According to FIG. 7B suggested a movement compensation mechanism, which enable horizontal movement in as straight line when the cleaning head apparatus moves vertically continuously. The compensation mechanism is comprised of rail 82B mounted on structure base 82 having two side frames 86, such the rail 82B can slide up or down, while the trolley 80 moves horizontally along the rail.

The references cited herein teach many principles that are applicable to the present invention. Therefore the full contents of these publications are incorporated by reference herein where appropriate for teachings of additional or alternative details, features and/or technical background.

It should be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. A cleaning head apparatus operated by a carrier unit for cleaning a target surface, wherein the carrier unit moves the cleaning head apparatus along the target surface, said cleaning head apparatus comprised of:
at least two loop straps attached next to each other by a main structured, each strap stretched and rolled on two axles operated by an engine, wherein at each cleaning session each strap has one part in dry state and one part in wet state, such that the dry part faces opposite direction of the wet part;
drying mechanism for operating on at least one part of the strap at pre-defined time period;
wetting mechanism for spraying fluid at least one part of the strap at pre-defined time period;
wherein at each cleaning session the cleaning head apparatus moves along at least one predefined path;
wherein rolling of the straps is controlled, such that straps are not rolled during the movement of the cleaning head apparatus across the surface and are rolled, when the cleaning head apparatus reaches a pre-defined location along the target surface, such as part of the time the dry side faces the surface and part of the time the wet side faces the surface.

2. The cleaning head apparatus of claim 1 wherein, the strap with the wet part is facing the surface ahead of strap with the dry part facing the surface, in relation to the cleaning head apparatus movement direction.

3. The cleaning head apparatus of claim 1 wherein the straps are rolled when the cleaning apparatus reaches the edge of the target surface.

4. The cleaning apparatus of claim 1 the drying mechanism is activated during the enrolment of the straps toward a part of one strap which is currently in wet status, once the cleaning apparatus reaches the end of the of the surface.

5. The cleaning head apparatus of claim 1 the wetting mechanism is activated during the enrolment of the straps toward a part of one strap which is currency in dry status, once the cleaning apparatus reaches the end of the of the surface.

6. The cleaning head apparatus of claim 1 further comprising a squeegee integrated in-between the two straps such as the squeegee swap the water left on the surface.

7. The cleaning head apparatus of claim 1 further comprising a vacuum entrance integrated in-between the two straps such as the vacuum device draw the water left on the surface.

8. The cleaning head apparatus of claim 1, wherein the a carrier unit comprises a vacuum pump for operating the vacuum entrance, a fluid source for wetting the straps and energy source for operating the engine.

9. The cleaning head apparatus of claim 1, wherein the straps constantly are in contact with the target surface, at each cleaning session when the cleaning head apparatus moves along a predefined path and when the cleaning head apparatus changes location between different paths.

10. The cleaning head apparatus of claim 1 wherein the engine creates polishing movements of the straps, by moving thereof slightly back and forth during the cleaning session when the cleaning head apparatus moves along a predefined path.
